(19) United States
(12) Patent Application Publication
(10) Pub. No.: US 2026/0186015 A1
(43) Pub. Date: Jul. 2, 2026

(54) CAMERA-BASED VEHICLE SPEED ESTIMATION

(71) Applicant: VIGILANT SOLUTIONS, LLC, Livermore, CA (US)

(72) Inventors: Phong Quang Dinh, Ho Chi Minh City (VN); William Fincannon, Allen, TX (US); Phong Truong Hoai, Ho Chi Minh City (VN)

(21) Appl. No.: 19/005,735

(22) Filed: Dec. 30, 2024

(51) Int. Cl. G01P 3/38; G06T 7/246; G06V 10/82; G08G 1/017; G08G 1/054

(52) U.S. Cl. CPC G01P 3/38; G06T 7/246; G06V 10/82; G08G 1/0175; G08G 1/054; G06T 2207/10016; G06T 2207/30252

(57) ABSTRACT

A system may include a camera for capturing a plurality of sequential images including a first image and a second image, both featuring a vehicle. The system may include an electronic processor configured to receive, from the camera, the first image and the second image. The electronic processor is configured to determine an actual vehicle dimension by analyzing one of the plurality of sequential images. The electronic processor is configured to determine a scaled dimension corresponding to the actual vehicle dimension. The electronic processor is configured to determine a vehicle/image ratio between the scaled dimension and the actual vehicle dimension. The electronic processor is configured to determine an actual distance traveled for the vehicle by multiplying the vehicle/image ratio by a scaled distance traveled and determine a speed for the vehicle by dividing the actual distance traveled by a time traveled.

### BACKGROUND

Examples herein relate to estimating the speed of a vehicle based on images received from a camera.

Vehicle speed estimation is important for, among other things, traffic management, road safety, and autonomous driving. Traditional methods often rely on specialized sensors, fixed road infrastructure, or both. The reliance of traditional methods on specialized sensors and fixed road infrastructure limits the flexibility and scalability of those methods.

### BRIEF DESCRIPTION OF THE DRAWINGS

FIG. 1 illustrates a speed determination system according to some aspects.

FIG. 2 illustrates a flow chart for determining a vehicle/image ratio for the speed determination system of FIG. 1.

FIG. 3 illustrates a landmark model with landmark points associated with a vehicle according to some aspects.

FIG. 4 illustrates a first and second image captured of a vehicle according to some aspects.

FIG. 5 illustrates a flow diagram for a method for determining the speed of a vehicle according to some aspects.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

As noted, traditional methods of determining vehicle speed are often difficult to adapt and scale. Camera-based approaches offer a more cost-effective and versatile solution, but often require camera calibration or road markings.

Therefore, providing a robust and accurate speed estimation solution that works solely from an uncalibrated camera, without requiring any external information, would provide cost savings and increased applications utilizing existing cameras.

The systems described herein enable, among other things, a determination of a vehicle speed by implementing vehicle make/model recognition to determine a vehicle's actual size and vehicle landmark detection to determine a scalable ratio. With the information gathered, the system is configured to determine a vehicle size in a captured image and calculate a distance traveled. Utilizing timestamps from sequential images and the distance traveled, a vehicle speed can be derived.

Utilizing a single camera to monitor the speed of a vehicle may be useful in high-risk areas or speed violation hotspots to automatically detect and record vehicles exceeding the speed limit. Further, in some instances, the system can warn drivers or autonomous vehicles about potential collisions based on the relative speed between vehicles.

In one example, an ALPR (Automated License Plate Readers) system may utilize the speed estimation system described herein to calculate and/or determine fines. Further, in another example with a surveillance camera, the speed estimation system can determine speeds without requiring prior calibration information. This enables analysis of large amounts of video data. For example, in helping authorities when searching for clues to quickly approach or narrow down a suspect.

One example provides a system for determining a speed of a vehicle. The system includes a camera for capturing a plurality of sequential images of a vehicle. The plurality of sequential images includes a first image and a second image. The system includes an electronic processor configured to receive, from the camera, the first image and the second image. The electronic processor is configured to determine an actual vehicle dimension by analyzing one of the plurality of sequential images. The electronic processor is also configured to determine a scaled dimension from the first image or the second image, the scaled dimension corresponding to the actual vehicle dimension. The electronic processor is also configured to determine a vehicle/image ratio between the scaled dimension and the actual vehicle dimension. The electronic processor is also configured to determine a time traveled for the vehicle between the first image and the second image. The electronic processor determines a scaled distance traveled between the first image and the second image and an actual distance traveled for the vehicle by multiplying the vehicle/image ratio by the scaled distance traveled and determine a speed for the vehicle by dividing the actual distance traveled by the time traveled.

In one example electronic processor is configured to determine the vehicle/image ratio by determining a first scaled dimension corresponding to the actual vehicle dimension from the first image, determining a first ratio between the first scaled dimension and the actual vehicle dimension, determining a second scaled dimension corresponding to the actual vehicle dimension from the second image, determining a second ratio between the second scaled dimension and the actual vehicle dimension, and calculating an average of the first ratio and the second ratio to define the vehicle/image ratio.

Another example provides a non-transitory computer readable medium storing instructions that, when executed by an electronic processor, cause the electronic processor to perform a set of operations. The set of operations includes receiving, from a camera, sequential images of a vehicle including a first image and a second image captured after the first image. The set of operations also includes determining an actual vehicle dimension by analyzing one of the sequential images; determining a scaled dimension from the first image or the second image, where the scaled dimension corresponds to the actual vehicle dimension. The set of operations also includes determining a vehicle/image ratio between the scaled dimension and the actual vehicle dimension; determining a time traveled for the vehicle between the first image and the second image; and determining a scaled distance traveled between the first image and the second image. The set of operations also includes determining an actual distance traveled for the vehicle by multiplying the vehicle/image ratio by the scaled distance traveled and determining a speed for the vehicle by dividing the actual distance traveled by the time traveled.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

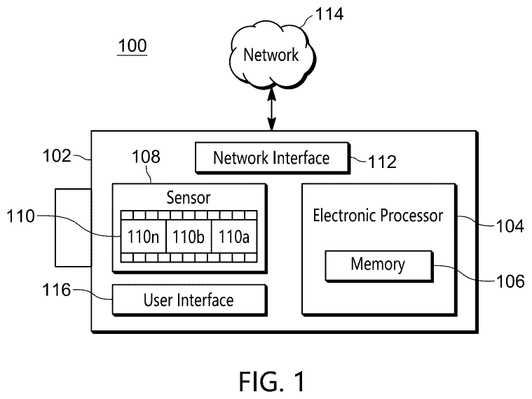

Referring now to the drawings, FIG. 1 illustrates a speed determination system 100, according to some examples. The speed determination system 100 includes a camera 102, an electronic processor 104, and a memory 106. The speed determination system 100 may include additional hardware and software that perform the processes and functions described herein. For example, the system could include two cameras. However, one advantage of some implementations is that only one camera is needed.

The camera 102 includes an image sensor 108 for capturing a plurality of sequential images 110. The camera could include more than one image sensor. In the example shown, the sequential images include a first image 110a and a second image 110b captured after the first image 110a. Additional images 110n may be captured before, after, or between the first and second images 110a, 110b. The camera 102 may be a digital video camera and the image sensor 108 may output captured light as digital data. For example, the image sensor 108 may be a CMOS, NMOS, or CCD image sensor.

The image sensor 108 may be operable to sense light in one or more frequency ranges. (Of course, light may also be categorized by wavelength.) For example, the image sensor 108 may be operable to sense light in a range that substantially corresponds to the visible light frequency range. In other examples, the image sensor 108 may be operable to sense light outside the visible light range, such as in the infrared and/or ultraviolet range. In other examples, the camera 102 may be a multi-sensor camera that includes two or more sensors that are operable to sense light in different frequency ranges.

The camera 102 may be a dedicated camera. A dedicated camera generally refers to a camera whose principal features is to capture images or video. In some examples, the dedicated camera may perform functions associated to the captured images or video, For example, the dedicated camera may process the image data produced by it or by another camera 102. In some instances, the dedicated camera is a surveillance camera, for example, a pan-tilt-zoom camera, dome camera, in-ceiling camera, box camera, or bullet camera.

The camera 102 may alternatively be an embedded camera. Generally, an embedded camera refers to a camera that is embedded within a device that is operational to perform functions that are unrelated to the captured image or video. For example, the embedded camera may be a camera in a laptop, tablet, drone device, smartphone, video game console, or controller.

The electronic processor 104 may be integral with the camera 102 as illustrated. In another example, while not illustrated, the electronic processor 104 may be a separate processor for processing image data output by the camera 102. The electronic processor may be a computer and include one or more processors and one or more memory devices coupled to the processor. The electronic processor 104 may be implemented by a processing circuit having one or more circuit units, including a central processing unit (CPU), digital signal processor (DSP), graphics processing unit (GPU) embedded processor, a vision or video processing unit (VPU) embedded processor, etc., and a combination thereof operating independently or in parallel, including possibly operating redundantly. The processing circuit may be implemented by one or more integrated circuits (IC), including being implemented by a monolithic integrated circuit (MIC), an Application Specific Integrated Circuit (ASIC), a Field Programmable Gate Array (FPGA), etc. or any combination thereof. The processing circuit may be implemented as a programmable logic controller (PLC). The electronic processor 104 may include all or part of the memory 106 and be in wired communication with the memory 106 as illustrated. It is further contemplated that all or part of the memory 106 is separate from the electronic processor and accessible wirelessly. The electronic processor 104 may be configured to execute a non-transitory computer readable medium storing instructions that to cause the electronic processor 104 to perform a set of operations and/or instructions (e.g., an operating system and/or application programs), which can be stored in the memory 106.

The memory 106 stores information related to operation of the speed determination system 100 and software or program instructions that, when executed by the electronic processor 104, cause the electronic processor 104 to perform, among other things, speed determination functions (that are described in more detail below).

The memory 106 may include a local memory (e.g. a random access memory and a cache memory) employed during execution of program instructions. The memory 106 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, dynamic random access memory (DRAM), universal serial bus (USB) connected memory units, magnetic storage, optical storage, magneto-optical storage, etc. or any combination thereof. The memory 106 may be a volatile memory, a non-volatile memory, or a combination thereof.

The speed determination system 100 may also include one or more network interfaces 112 to connect the camera 102 to a network 114. The camera 102 is operable to output image data representing captured images and transmit the image data over the network 114. For example, the network interface 112 includes one or more transmitter/receiver systems for transmitting and receiving the image data via electronic signals over the network 114.

It will be understood that the network 114 may be any communications network that provides reception and transmission of data. For example, the network 114 may be a local area network, external network (e.g. WAN, the Internet) or a combination thereof. In other examples, the network 114 may include a cloud network.

A plurality of the components of the camera 102 may be implemented together within a system on a chip (SOC). For example, the electronic processor 104, the memory 106 and the network interface 112 may be implemented within a SOC. Furthermore, when implemented in this way, both a general-purpose processor and DSP may be implemented together within the SOC.

In some instances, the speed determination system 100 includes a user interface 116. In one example the user interface 116 is integral with the camera 102. It is further contemplated that the user interface 116 is integral with an external device, e.g. a smartphone or tablet, for controlling the camera 102. The user interface 116 may include one or more buttons, knobs, dials, or the like (virtual or physical) for controlling operation of the camera 102 (e.g., a play button, a record button, a fast forward and/or rewind knob/button etc.). The user interface 116 may also include a display (e.g., a touch screen display) configured to display, among other things, the plurality of sequential images 110, timestamps, seasons, weather conditions and/or the like.

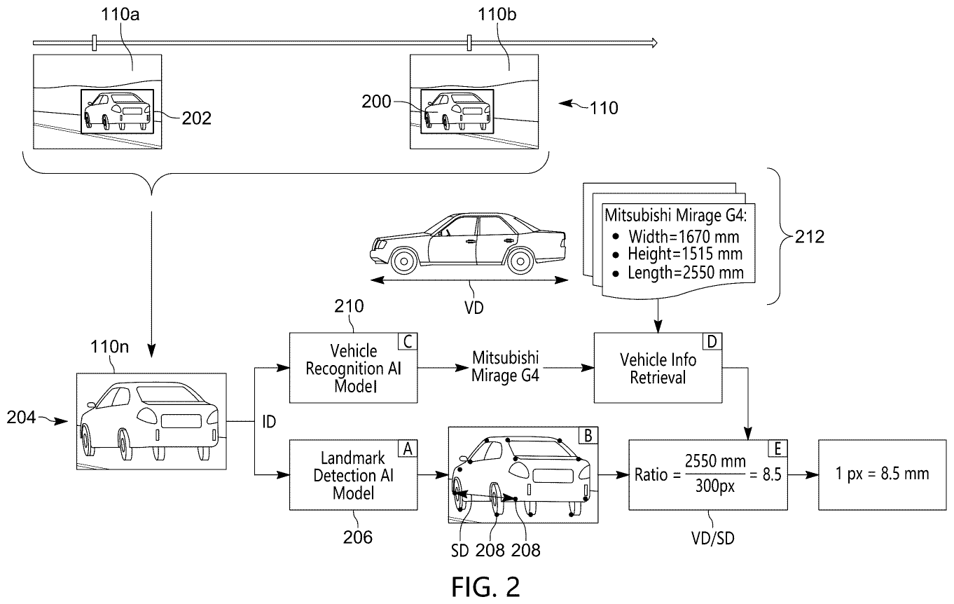

FIG. 2 illustrates a flow chart for determining a vehicle/image ratio for the speed determination system 100. The camera 102 is configured to capture the plurality of sequential images 110, and the speed determination system 100 is configured to determine if a vehicle 200 is present in the plurality of sequential images 110. In one example, an AI-powered object detection model is used to identify the vehicle within the overview image. A detected vehicle may be indicated by a bounding box 202. Once the vehicle 200 is located, it may be cropped to form a separate vehicle image 204 enhanced to be more in focus.

It is further contemplated that a vehicle tracking mechanism may be implemented in order to ensure that the vehicle 200 depicted in the plurality of sequential images 110 is the same vehicle across different frames or viewpoints. The vehicle tracking mechanism may utilize techniques such as feature matching, motion prediction, appearance modeling, or license plate matching to track the vehicle's movement and maintain its identity over time.

At step A, upon determining that a vehicle 200 is present in the plurality of sequential images 110, image data (“ID”) associated with any one of the plurality of sequential images 110, by way of example, image 110n, is sent to a landmark detection AI model 206.

At step B, the image 110n is processed to determine a plurality of landmark points 208 for the vehicle 200. The electronic processor 104 is configured to determine a scaled dimension (“SD”) from the image 110n, by way of example, a length associated with the vehicle 200 in the image 110n is determined to be 300 pixels.

At step C, the image data ID is also sent to a learning machine to determine make and model information of the vehicle. By way of example the learning machine is a vehicle recognition AI model 210. The vehicle recognition AI model 210 is trained to receive the image 110n containing the vehicle 200 as input and output the corresponding make and model of the vehicle 200. By way of example, the vehicle recognition AI model 210 determines the vehicle is a Mitsubishi Mirage G4.

At step D, the electronic processor 104 determines an actual vehicle dimension (“VD”) from a database 212. The database 212 includes data on vehicle makes, models, and corresponding dimensions (length, width, height). The vehicle data may be obtained from various sources including, e.g., vehicle manufacturer websites. The make and model information is provided by the vehicle recognition AI model 210 as input. The information is utilized to query the database. Then, based on the vehicle make and model, the database 212 returns dimensions associated with the vehicle, e.g. length, width, and height. By way of example, the actual length of the vehicle is determined to be 2550 mm. The vehicle dimension VD ultimately used for determining the vehicle speed corresponds to the determined scaled dimension SD.

At step E, the electronic processor 104 determines the vehicle/image ratio between the actual vehicle dimension VD and the scaled dimension SD:

$$ratio = \frac{VD}{SD} \qquad ( Equation 1 )$$

By way of example, the ratio is 2550 mm/300 px=8.5 mm/pixel, and therefore 1 pixel corresponds to 8.5 mm.

While described as utilizing data from the image 110n, the process of determining any of the vehicle dimensions may be carried out on a different the plurality of sequential images 110 as described above including the first image 110a or the second image 110b.

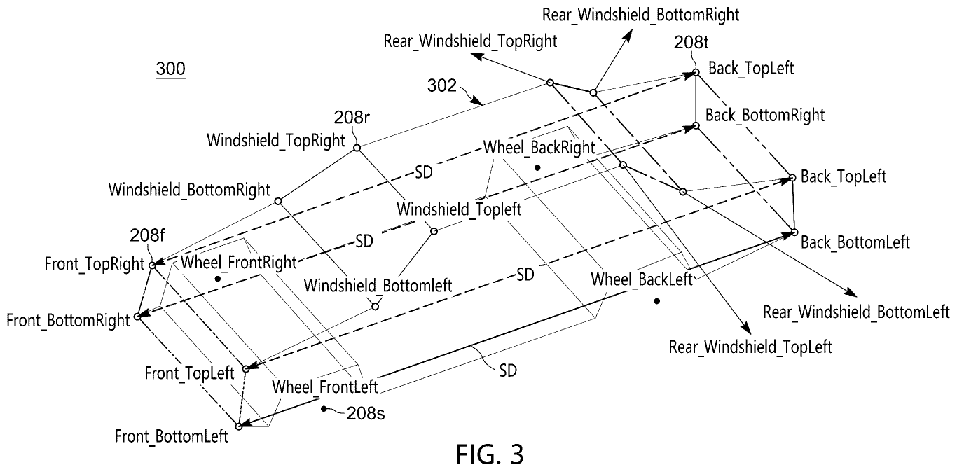

Turning to FIG. 3, an example landmark model 300 with the landmark points 208 is illustrated. Landmark points 208 are associated with a localization of important vehicle joints. Connecting the landmark points 208 builds a skeleton 302 of the vehicle containing the vehicle's structural information. By way of example, the landmark model 300 includes twenty landmark points 208 with their specific locations and corresponding labels shown. The landmark points 208 may include front points 208f on a front of the vehicle 200, roof points 208r on a roof of the vehicle 200, trunk points 208t on a trunk of the vehicle 200, and surface contact points 208s where tires of the vehicle make surface contact with the road. The landmark points 208 may also include points on a side-mirror of the vehicle, on a fender of the vehicle, or on a bumper of the vehicle. It should be understood, that while twenty landmark points 208 are illustrated, more or less landmark points 208 are contemplated.

The landmark detection AI model 206 is trained to detect the landmark points 208. The landmark detection AI model 206 receives an image, e.g., the first image 110a, as an input. A set of coordinates corresponding to the locations of the detected landmark points 208 is then determined. An illustrative example of the landmark detection AI model 206 output is provided below:

{
“FRONT_TopLeft”: [x1, y1],
“FRONT_TopRight”: [x2, y2],
...
“WHEEL_BackRight”: [xk, yk],
}

The electronic processor 104 is configured to determine the scaled dimension SD by measuring the Euclidean distance between the following pairs of landmark points 208: FRONT_TopLeft and BACK_TopLeft, FRONT_BottomLeft and BACK_BottomLeft, FRONT_TopRight and BACK_TopRight, FRONT_BottomRight and BACK_BottomRight. The distances are each illustrated in dashed line. The determined scaled dimension is illustrated in solid line, and by way of example, determined between the FRONT_BottomLeft and BACK_BottomLeft landmark points 208:

Scaled_Dimension=Euclidean distance (FRONT_BottomLeft, BACK_BottomLeft)

$$SD = \sqrt{( {( {x}_{1} - {x}_{2} )}^{2} + {( {y}_{1} - {y}_{2} )}^{2} )} \qquad ( Equation 2 )$$

The output is the scaled dimension SD and determined to be 300 pixels as illustrated in FIG. 2.

Since the scaled dimension SD can be determined from any of the four pairs of landmark points 208 described above, in the event more than one of these pairs is present in the image 110n, a more accurate scaled dimension may be determined by averaging the available pairs:

$$SD = \frac{SD 1 + SD 2 + … SDn}{n} \qquad ( Equation 3 )$$

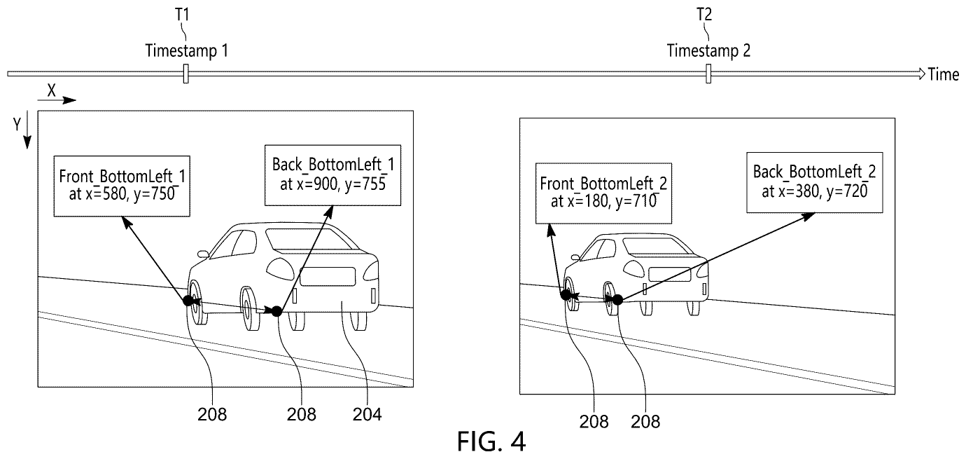

FIG. 4 illustrates the first image 110a and the second image 110b. Each of the first image 110a and the second image 110b include an associated timestamp. For example, Timestamp 1 (“T1”) and Timestamp 2 (“T2”). The electronic processor 104 is configured to detect the landmark points 208 based on one or more landmark points 208 detectable on both the first image 110a and the second image 110b.

As previously described with regards to FIG. 3, the scaled dimension SD associated with each of the first image 110a and the second image 110b is determined. By way of example, using Equation 2:

$${SD}_{a} = \sqrt{( {( 900 - 580 )}^{2} + {( 755 - 750 )}^{2} )} = 320 pixels$$

$${SD}_{b} = \sqrt{( {( 380 - 180 )}^{2} + {( 720 - 710 )}^{2} )} = 200 pixels$$

Utilizing the landmark points 208 detected on both images 110a, 110b, a vehicle/image ratio for each image is determined. As previously discussed herein the actual vehicle dimension VD is 2550 mm. The vehicle/image ratio associated with the first image 110a is “ratio1” and the vehicle/image ratio associated with the second image 110b is “ratio2”. By way of example using Equation 1:

$$ratio 1 = \frac{VD}{{SD}_{a}} = \frac{2550}{320} = 7 \text{.97}$$

$$ratio 2 = \frac{VD}{{SD}_{b}} = \frac{2550}{200} = 12.75$$

In some examples, the electronic processor 104 is configured to determine a scaled distance traveled (“SDT”) by one of the landmark points 208. The scaled distance traveled SDT is measured between one or more landmark points 208 in the first image 110a and the same one or more landmark points 208 in the second image 110b:

Scaled_Distance_Traveled=Euclidean distance (BACK_BottomLeft_1, BACKBottomLeft_2)

$$SDT = \sqrt{( {( {x}_{1} - {x}_{2} )}^{2} + {( {y}_{1} - {y}_{2} )}^{2} )} = \sqrt{( {( 900 - 380 )}^{2} + {( 755 - 720 )}^{2} )} = 521.18 pixels \qquad ( Equation 4 )$$

An estimate for the actual distance traveled (“ADT”) can now be determined.

$$ADT = SDT * ratio \qquad ( Equation 5 )$$

Utilizing ratio1 and ratio 2, two different actual distance traveled values result:

$$= 521.18 * 7.97 = 4153.8 mm$$

$$= 521.18 * 12.75 = 6645.05 mm$$

As previously discussed herein, an average produces a more accurate measurement. Therefore, utilizing an average of the ratios to determine the actual distance traveled ADT is also contemplated (in at least some examples):

$$ADT = SDT * \frac{ratio 1 + ratio 2}{2} = 52 \; 1.18 * \frac{7.97 + 12.75}{2} = 5399.42 mm \qquad ( Equation 6 )$$

The speed of the vehicle can be determined using the actual distance traveled ADT and the difference between the time stamps:

$$S = \frac{ADT}{T 2 - T 1} \qquad ( Equation 7 )$$

By way of example, the difference between the two timestamps is 300 ms, which would equate to a speed of 14 m/s for ratio1 and of 22 m/s for ratio 2. Using Equations 6 and 7, a more accurate speed (“s”) can be determined:

$$s = \frac{SDT * ( ratio 1 + ratio 2 ) / 2}{\vert T 1 - T 2 \vert} \qquad ( Equation 8 )$$

$$s = \frac{5 399.42 mm}{300 ms} = 18 m / s$$

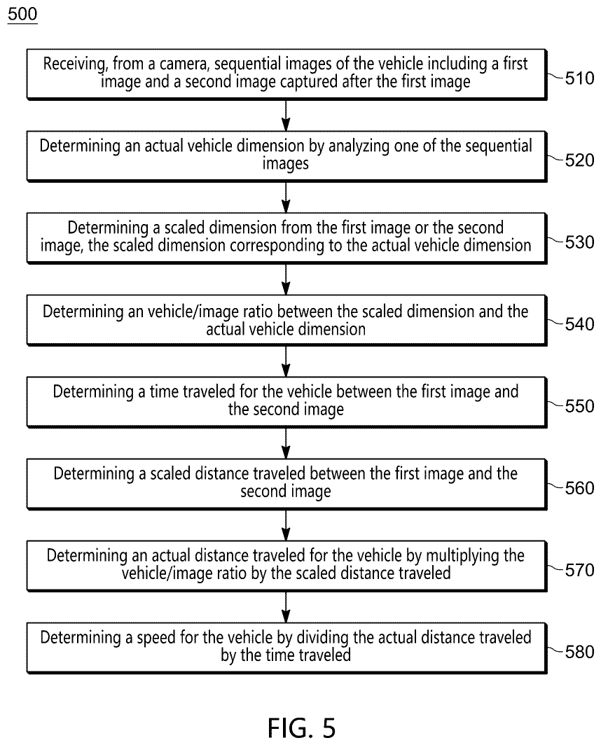

FIG. 5 illustrates a flow diagram for a method 500 for determining the speed s of the vehicle 200 according to aspects.

At block 510 the method 500 includes receiving from the camera 102, the plurality of sequential images 110 including the first image 110a and the second image 110b.

At block 520 the method includes determining, with the electronic processor 104, the actual vehicle dimension VD by analyzing one of the plurality of sequential images, by way of example the image 110n. Analyzing one of the plurality of sequential images 110 includes inputting the first image 110a and/or the second image 110b into a learning machine to determine make and model information of the vehicle 200. The method 500 may further include determining a known dimension from the database 212, including one of a length, width, and/or height dimension matching the make and model information.

At block 530, the method 500 includes determining, with the electronic processor 104, the scaled dimension SD from the first image 110a or the second image 110b, the scaled dimension SD corresponding to the actual vehicle dimension VD.

At block 540, the method 500 includes determining, with the electronic processor 104, the vehicle/image ratio between the actual vehicle dimension VD and the scaled dimension SD.

At block 550, the method 500 includes determining a time traveled for the vehicle 200 between the first image 110a and the second image 110b by taking a difference between the first timestamp T1 and the second timestamp T2. In some examples, the time traveled for the vehicle 200 is greater than or equal to 50 ms.

At block 560, the method 500 includes determining, with the electronic processor 104, the scaled distance traveled SDT between the first image 110a and the second image 110b.

At block 570, the method 500, includes determining, the actual distance traveled ADT for the vehicle 200 by multiplying the vehicle/image ratio by the scaled distance traveled SDT. More specifically, the method 500 may include determining ratio1 and ratio2, calculating an average of ratio1 and ratio2, to define the vehicle/image ratio used to determine the actual distance traveled ADT.

At block 580, the method includes determining a speed for the vehicle by dividing the actual distance traveled ADT by the time traveled. Determining the speed for the vehicle includes estimating a speed at which the vehicle is traveling based on the information gathered. As described herein, utilizing an average of ratios provides for a more accurate speed estimation. While two ratios are determined and averaged, it should be understood that additional ratios from additional images may also be utilized.

The method 500 may further include detecting landmark points 208 based on one or more landmark points 208 visible/detectable on both the first image 110a and the second image 110b.

Benefits associated with the system described herein include, among other things, that the speed of a vehicle can be determined with a single camera, by way of example a single traffic camera. Utilizing a single camera eliminates the need to calibrate between two separate cameras.

In some examples, the electronic processor 104 associated with the camera 102 is configured to: record the speed s in the memory 106 of the speed detection system 100; cross-check the speed s with a speed limit for the area in which the vehicle 200 is located; download the speed s to a database, e.g. located in the network 114; monitor and analyze traffic flow for the area in which the camera 102 is located, detect incidents, e.g. sudden speed changes across multiple vehicles, having occurred in the area surrounding the camera 102; reconstruct accidents, e.g. analyze vehicle speeds captured prior to an accident occurring; and/or conduct traffic studies and urban planning.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot alter radio transmitter configurations, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for determining a speed of a vehicle, the system comprising:
a camera for capturing a plurality of sequential images of a vehicle, the plurality of sequential images including a first image and a second image; and
an electronic processor configured to:
receive, from the camera, the first image and the second image;
determine an actual vehicle dimension by analyzing one of the plurality of sequential images;
determine a scaled dimension from the first image or the second image, the scaled dimension corresponding to the actual vehicle dimension;
determine a vehicle/image ratio between the scaled dimension and the actual vehicle dimension;
determine a time traveled for the vehicle between the first image and the second image;
determine a scaled distance traveled between the first image and the second image;
determine an actual distance traveled for the vehicle by multiplying the vehicle/image ratio by the scaled distance traveled; and
determine a speed for the vehicle by dividing the actual distance traveled by the time traveled.

2. The system of claim 1 wherein the electronic processor is configured to determine the vehicle/image ratio by determining a first scaled dimension corresponding to the actual vehicle dimension from the first image, determining a first ratio between the first scaled dimension and the actual vehicle dimension, determining a second scaled dimension corresponding to the actual vehicle dimension from the second image, determining a second ratio between the second scaled dimension and the actual vehicle dimension, and calculating an average of the first ratio and the second ratio to define the vehicle/image ratio.

3. The system of claim 1, wherein the first image includes a first timestamp, and the second image includes a second timestamp.

4. The system of claim 3, wherein the electronic processor is configured to calculate the time traveled by taking a difference between the first timestamp and the second timestamp.

5. The system of claim 4, wherein the time traveled is greater than or equal to 50 ms.

6. The system of claim 1, wherein analyzing one of the plurality of sequential images comprises inputting the first image and/or the second image into a learning machine to determine make and model information of the vehicle.

7. The system of claim 6, further comprising determining a known dimension, including a of a length, width, and/or height dimension matching the make and model information.

8. The system of claim 7, wherein the scaled dimension is based on the known dimension and a pixel size for the plurality of sequential images.

9. The system of claim 1, wherein the electronic processor is further configured to detect landmark points based on one or more points detectable on both the first image and the second image.

10. The system of claim 9, wherein the scaled distance traveled is measured between one or more landmark points in the first image and the same one or more landmark points in the second image.

11. The system of claim 10, wherein the one or more landmark points include points on a roof of the vehicle, on a side-mirror of the vehicle, on a trunk of the vehicle, on a fender of the vehicle, on a bumper of the vehicle, or where one or more tires of the vehicle makes surface contact.

12. The system of claim 1, wherein the camera is a single traffic camera.

13. The system of claim 1, wherein the electronic processor is further configured to, selected from the group consisting of:
record the speed in a memory of the system,
cross-check the speed with a speed limit,
download the speed to a database,
monitor and analyze traffic flow,
detect incidents,
conduct traffic studies and urban planning, and
reconstruct accidents.

14. A method for determining a speed of a vehicle, the method comprising:
receiving, from a camera, sequential images of the vehicle including a first image and a second image captured after the first image;
determining an actual vehicle dimension by analyzing one of the sequential images;
determining a scaled dimension from the first image or the second image, the scaled dimension corresponding to the actual vehicle dimension;
determining a vehicle/image ratio between the scaled dimension and the actual vehicle dimension;
determining a time traveled for the vehicle between the first image and the second image;
determining a scaled distance traveled between the first image and the second image;
determining an actual distance traveled for the vehicle by multiplying the vehicle/image ratio by the scaled distance traveled; and
determining a speed for the vehicle by dividing the actual distance traveled by the time traveled.

15. The method of claim 14, further comprising determining the vehicle/image ratio by determining a first scaled dimension corresponding to the actual vehicle dimension from the first image, determining a first ratio between the first scaled dimension and the actual vehicle dimension, determining a second scaled dimension corresponding to the actual vehicle dimension from the second image, determining a second ratio between the second scaled dimension and the actual vehicle dimension, and calculating an average of the first ratio and the second ratio to define the vehicle/image ratio.

16. The method of claim 14, further comprising calculating the time traveled by taking a difference between a first timestamp and a second timestamp.

17. The method of claim 14, wherein analyzing one of the sequential images comprises inputting the first image and/or the second image into a learning machine to determine make and model information of the vehicle.

18. The method of claim 17, further comprising determining a known dimension, including a of a length, width, and/or height dimension matching the make and model information.

19. The method of claim 14, further comprising detecting landmark points based on one or more points detectable on both the first image and the second image.

20. A non-transitory computer readable medium storing instructions that, when executed by an electronic processor, cause the electronic processor to perform a set of operations comprising:
receiving, from a camera, sequential images of a vehicle including a first image and a second image captured after the first image;
determining an actual vehicle dimension by analyzing one of the sequential images;
determining a scaled dimension from the first image or the second image, the scaled dimension corresponding to the actual vehicle dimension;
determining a vehicle/image ratio between the scaled dimension and the actual vehicle dimension;
determining a time traveled for the vehicle between the first image and the second image;
determining a scaled distance traveled between the first image and the second image;
determining an actual distance traveled for the vehicle by multiplying the vehicle/image ratio by the scaled distance traveled; and
determining a speed for the vehicle by dividing the actual distance traveled by the time traveled.
